(19) United States
(12) Patent Application Publication
(10) Pub. No.: US 2024/0136553 A1
(43) Pub. Date: Apr. 25, 2024

(54) DEVICE FOR SUPPLYING A PLURALITY OF CATHODES OF A FUEL SYSTEM

(71) Applicant: LIEBHERR-AEROSPACE TOULOUSE SAS, Toulouse (FR)

(72) Inventors: Karine PRINCE, Toulouse (FR); David LAVERGNE, Toulouse (FR); Cyril VAUCORET, Toulouse (FR)

(73) Assignee: LIEBHERR-AEROSPACE TOULOUSE SAS, Toulouse (FR)

(21) Appl. No.: 18/278,554

(22) PCT Filed: Feb. 22, 2022
(86) PCT No.: PCT/EP2022/054448

§ 371 Date: Aug. 22, 2023

(30) Foreign Application Priority Data
Feb. 23, 2021 (FR) FR2101756

(51) Int. Cl. H01M 8/04746; H01M 8/04082; H01M 8/0432; H01M 8/0438

(52) U.S. Cl. CPC H01M 8/04753; H01M 8/04201; H01M 8/04335; H01M 8/04395

(57) ABSTRACT

The invention relates to a supply device for compressed air to a plurality of cathodes (100a-100d) of a fuel cell system, characterized in that it comprises a motorized compressor (12) configured to provide a source of compressed air to all of the cathodes (100a-100d), a group of ducts configured to conduct the compressed air to each cathode (100a-100d), for each cathode (100a-100d), a proportioning valve (20a-20d) upstream or downstream of said cathode (100a-100d) which is configured to regulate the flow rate of compressed air passing through said cathode (100a-100d), anti-pumping protection means (30, 32) configured to allow the flow of a minimum flow rate of compressed air leaving the compressor (12), and a control device (24) configured to control the speed of the compressor (12) and the opening or closing of each proportioning valve (20a-20d) and/or the operation of the anti-pumping protection means (30, 32).

### TECHNICAL FIELD OF THE INVENTION

The invention relates to a supply device for cathodes of a fuel cell system. In particular, the invention relates to a supply device making it possible to mutualize the supply to a plurality of cathodes of fuel cells forming a fuel cell system.

### TECHNOLOGICAL BACKGROUND

Nowadays, there is a growing trend to provide transport vehicles, in particular aircraft, with fuel cells insofar as these cells form clean, reliable and flexible energy sources.

The principle on which a fuel cell (also referred to by the acronym FC), such as a hydrogen cell, is based rests on the redox reaction between dihydrogen and dioxygcn. These two molecules constitute the chemical fuel in which energy can be stored within a fuel cell application.

The fuel cell as such is thus an electric generator with two electrodes which allows the generation of electrical energy by oxidation on one electrode of a reducing fuel, such as hydrogen, coupled with a reduction on the other electrode of an oxidant, such as oxygen from the air for example.

The redox reaction of the cell allows the generation not only of electricity but also of by-products such as water, heat and air depleted of oxygen.

In particular, the oxidation reaction at the anode makes it possible to decompose hydrogen molecules in contact with a catalyst in order to release electrons and discharge heat. The reduction reaction at the cathode makes it possible to form oxygen ions by contact between the oxygen and the electrons released by the oxidation. Furthermore, the hydrogen protons recombine with the oxygen ions to form water.

The oxygen supply to the cathode is effected e.g. via compressed air, containing sufficient oxygen to allow the reaction.

In an aeronautical, rail, maritime or automobile vehicle, the compressed air is provided by a compressor supplied with air drawn e.g. from the outside via an external air inlet.

In a fuel cell system, a plurality of cathodes must be supplied, these cathodes appertaining to different fuel cells, e.g. connected in parallel or in series depending on the applications.

Current practice consists of providing a supply to each cathode by a dedicated compressor. Flow rate control is effected via a back pressure valve located downstream of the cell.

A technology which is optimized in terms of performance and purity of the air sent to the fuel cell system for the compressor is centrifugal compressor technology. However, this technology has a critical point which must be taken into consideration, which is protection against the pumping phenomenon which appears when the compressed flow rate is too low for a given level of pressure.

The inventors have sought a solution to the supply to a plurality of cathodes making it possible to limit the number of components and able to be optimized for each cathode.

### AIMS OF THE INVENTION

The invention aims to provide a supply device for cathodes of a fuel cell system.

The invention aims in particular to provide, in at least one embodiment, a supply device making it possible to limit the number of components used compared to the prior art.

The invention also aims to provide, in at least one embodiment of the invention, a reliable and controllable supply device.

The invention also aims to provide, in at least one embodiment of the invention, a supply device which is protected against the pumping phenomenon.

### DESCRIPTION OF THE INVENTION

In order to do this, the invention relates to a device for supplying compressed air to a plurality of cathodes of a fuel cell system, characterized in that it comprises:
a motorized compressor configured to provide a source of compressed air to all the cathodes;
a group of ducts configured to conduct the compressed air towards each cathode;
for each cathode, a proportioning valve upstream or downstream of said cathode configured to regulate the flow rate of compressed air passing through said cathode;
anti-pumping protection means configured to permit the flow of a minimum flow rate of compressed air leaving the compressor,
a control device configured to control the speed of the compressor and the opening or closing of each proportioning valve and/or the operation of the anti-pumping protection means,

and in that at least one proportioning valve comprises a minimum passage section configured to permit the passage of a minimum flow rate of compressed air when said proportioning valve is in the closed position, each minimum passage section forming an anti-pumping protection means.

A supply device in accordance with the invention thus makes possible common supply to all of the cathodes by a motorized compressor. However, the supply to each cathode can be managed individually by the presence of the proportioning valves upstream or downstream of each cathode. A supply device in accordance with the invention can supply compressed air to a number of cathodes from two to some tens, preferably around ten cathodes.

The proportioning valve can be arranged upstream or downstream of the cathode for which it regulates the provision of compressed air. The proportioning valve is preferably arranged upstream because the compressed air is dryer upstream of the cathode, which makes possible greater rapidity and improved linearity in the regulation of the provision of compressed air.

The anti-pumping protection means make it possible to avoid the compressor breaking in particular when the cathodes have low requirements for compressed air. In fact, if a minimum flow rate is not flowing downstream of the compressor, pumping of the compressor can lead to its blades breaking.

The anti-pumping protection is ensured in particular at least by one or a plurality of proportioning valves. The proportioning valve or proportioning valves comprising the minimum passage section form the anti-pumping protection means. The proportioning valves ensure sufficient permeability in the supply device and ensure a minimum flow rate irrespective of the flow rate requirement for compressed air of the cathodes.

All the proportioning valves preferably have a minimum passage section.

Advantageously and in accordance with the invention, the anti-pumping protection means comprise a duct for bypassing all the cathodes, and a bypass valve configured to allow the flow of no compressed air, some of the compressed air or all the compressed air in the bypass duct, and in that the control device is configured to control the opening or closing of the bypass valve.

According to this aspect of the invention, the bypass circuit also makes it possible to protect against pumping of the compressor: the bypass valve permits the passage of a minimum flow rate in the bypass duct, in particular when the cathodes have low requirements for compressed air.

A supply device in accordance with the invention advantageously comprises means for measuring the pressure of the compressed air leaving the compressor, and in that the control device is configured to control the speed of the compressor and the opening or closing of each proportioning valve and the anti-pumping protection means depending on the data coming from the means for measuring the pressure of the compressed air leaving the compressor.

In particular, the pressure measurement makes it possible to anticipate possible pumping.

A supply device in accordance with the invention advantageously comprises means for measuring the temperature of the compressed air leaving the compressor, and in that the control device is configured to control the speed of the compressor and the opening or closing of each proportioning valve and the anti-pumping protection means depending on the data coming from the means for measuring the temperature of the compressed air leaving the compressor.

In particular, the measuring of the pressure and temperature can enable calculation of the flow rate of compressed air leaving the compressor.

A supply device in accordance with the invention advantageously comprises means for measuring the flow rate of the compressed air leaving the compressor, and in that the control device is configured to control the speed of the compressor and the opening or closing of each proportioning valve and the anti-pumping protection means depending on the data coming from the means for measuring the flow rate of the compressed air leaving the compressor.

According to these aspects of the invention, the measuring of the pressure, temperature and/or flow rate of the compressed air makes it possible to regulate the control of the proportioning valves, of the bypass valve if it is present, and of the speed of the compressor depending on the physical state of the compressed air leaving the compressor. The measuring of one or a plurality of these physical parameters also makes it possible to detect anomalies in operation or to prevent the occurrence of failure of the supply device.

Advantageously and in accordance with the invention, the control device is configured to control the speed of the compressor and the opening or closing of each proportioning valve and of the anti-pumping protection means depending on the power to be provided by the fuel cell system.

According to this aspect of the invention, the power demanded by the fuel cell system is taken into account in regulating the speed of the compressor and the control of the proportioning valves and of the anti-pumping protection means. This consideration of the power can be general (over the whole fuel cell system) and/or independent according to the fuel cell, so as to independently manage the compressed air supply to each cathode.

Advantageously and in accordance with the invention, the control device is supplied with power by at least one fuel cell of the fuel cell system.

According to this aspect of the invention, the control device is integrated into the fuel cell system and does not necessitate the use of an external power supply.

Advantageously and in accordance with the invention, the supply device comprises at least one heat exchanger arranged downstream of the compressor and upstream of the cathodes, which is configured to cool the compressed air.

According to this aspect of the invention, the heat exchanger makes it possible to adjust the temperature of the compressed air. The heat exchanger makes it possible to cool the compressed air intended for all the cathodes at once, which simplifies implementation and ensures greater homogeneity of the temperature of the compressed air entering each cathode, compared with the prior art.

A supply device in accordance with the invention advantageously comprises an outlet turbine arranged downstream of the cathodes and configured to regulate the pressure of the compressed air downstream of the cathodes.

According to this aspect of the invention, the outlet turbine makes it possible to control the pressure downstream of the cathodes, in particular to control the back pressure leaving the cathodes. The turbine is e.g. a turbine with a variable injection cross-section, or a turbine with a fixed injection cross-section associated with a bypass valve of the turbine opening when the back pressure is too great.

The invention also relates to a fuel cell system comprising a plurality of fuel cells, each fuel cell comprising a cathode configured to receive compressed air, characterized in that the fuel cell system comprises a supply device in accordance with the invention configured to supply compressed air to at least two cathodes of said fuel cell system.

The invention also relates to a supply device and a fuel cell system which are characterized in combination by all or some of the features mentioned above or below.

### LIST OF FIGURES

Other aims, features and advantages of the invention will become apparent upon reading the following description given solely in a non-limiting way and which makes reference to the attached figures in which:

FIG. 1 is a schematic view of a supply device in accordance with a first embodiment of the invention.

FIG. 2 is a schematic view of a supply device in accordance with a second embodiment of the invention.

FIG. 3 is a schematic view of a supply device in accordance with a third embodiment of the invention.

FIG. 4 is a schematic view of a supply device in accordance with a fourth embodiment of the invention.

### DETAILED DESCRIPTION OF AN EMBODIMENT OF THE INVENTION

In the figures, for the purposes of illustration and clarity, scales and proportions have not been strictly respected.

Furthermore, identical, similar or analogous elements are designated by the same reference signs in all the figures.

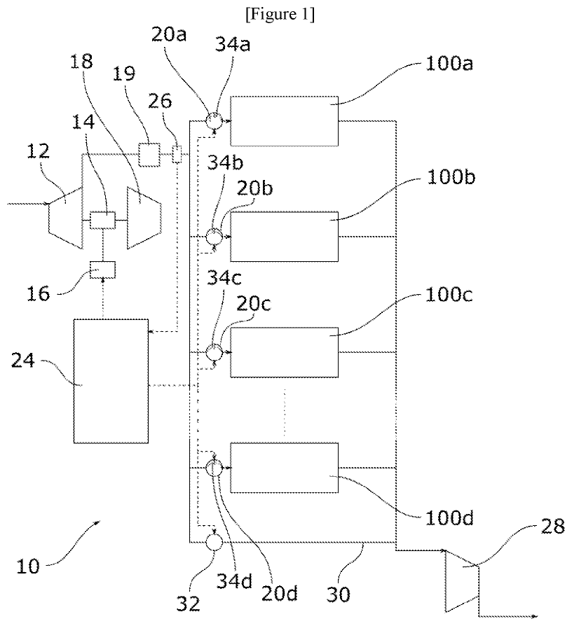

FIGS. 1 to 4 schematically illustrate a supply device 10 respectively according to a first embodiment of the invention, a second embodiment of the invention, a third embodiment of the invention and a fourth embodiment of the invention.

The supply device 10 is configured to supply compressed air to a plurality of cathodes 100a, 100b, 100c, 100d of a fuel cell system, only four of which are shown here. In practice, some tens of cathodes can be supplied with air, preferably around ten cathodes.

In order to do this, the supply device 10 comprises a compressor 12 motorized by a motor 14, the speed of which is controlled by a motor controller 16. The compressor 12 can form part of a motorized turbocompressor and thus be associated with a turbine 18 intended e.g. to assist the motor 14 in recovering energy by expansion of an air source. In particular, the air source can be the outlet of the supply device 10 as described below.

The compressor 12 makes it possible to provide the cathodes 100a, 100b, 100c, 100d with compressed air necessary to the operation of the fuel cells of the fuel cell system. The compressed air is thus distributed to each of the cathodes 100a, 100b, 100c, 100d. The compressed air can be cooled by one or a plurality of heat exchangers 19 arranged downstream of the compressor and upstream of the cathodes.

The supply device 10 comprises, for each cathode, a proportioning valve configured to regulate the flow rate of compressed air passing through said cathode.

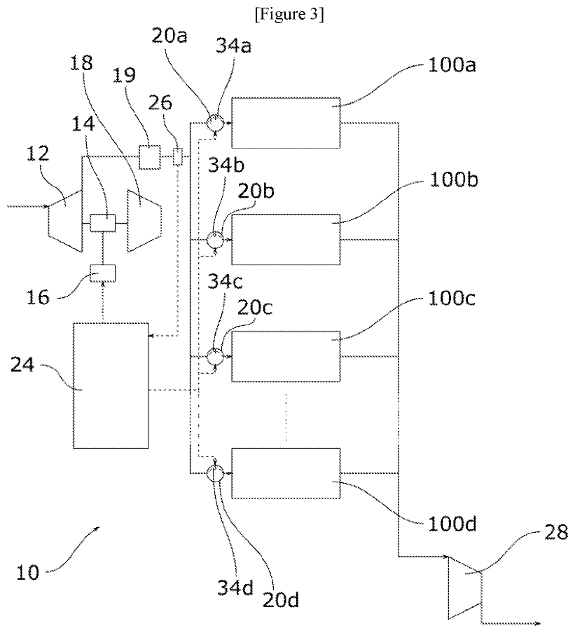

In the first and third embodiments, with reference to FIG. 1 and FIG. 3, the proportioning valves 20a, 20b, 20c, 20d are disposed upstream of the cathode.

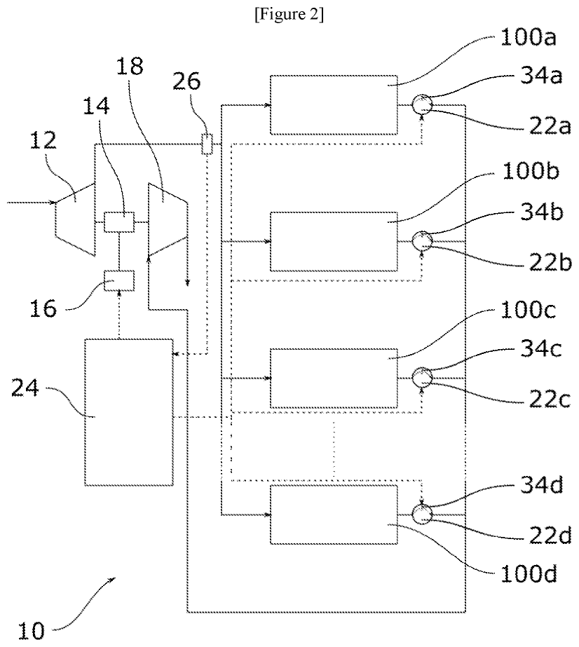

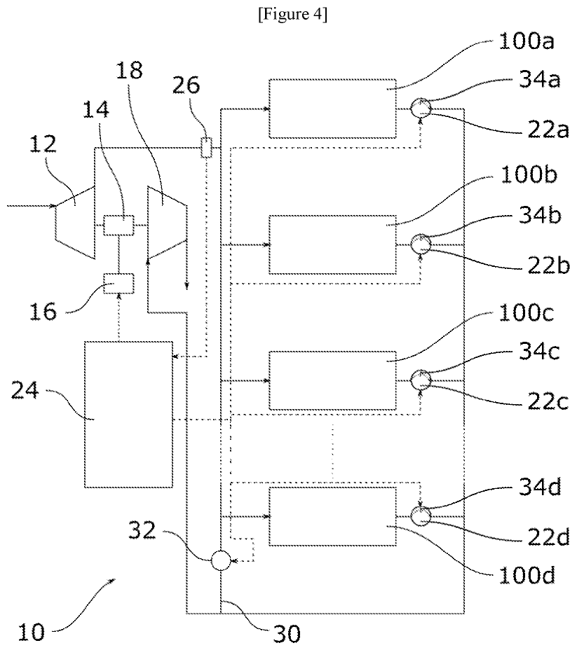

In the second and fourth embodiments, with reference to FIG. 2 and FIG. 4, the proportioning valves 22a, 22b, 22c, 22d are disposed downstream of the cathode.

In the four embodiments, the proportioning valves are controlled by a control device 24. The control device 24 receives data from a sensor 26 disposed at the outlet of the compressor 12, and configured to measure the pressure, temperature and/or flow rate of compressed air leaving the compressor 12.

According to the data received from the sensor 26 and the power requirements of the fuel cells of the fuel cell system, the control device 24 regulates the flow rate of compressed air passing through each cathode by virtue of the proportioning valves. The control device 24 is also configured to control the speed of the compressor 12 by sending commands to the controller 16 of the motor 14.

At the outlet of the cathodes, an outlet turbine 28 makes it possible to regulate the pressure of the compressed air, in particular to regulate the back pressure phenomena. In a preferred embodiment, as shown in FIG. 2 and FIG. 4, the turbine 28 and the turbine 18 assisting the motor 14 are one and the same turbine, some of the residual energy in the compressed air leaving the cathodes thus being recovered in order to assist the motor 14 driving the compressor 12, and thus to reduce its consumption of electricity.

The supply device 10 also comprises anti-pumping protection means which ensure the flow of a minimum flow rate of compressed air leaving the compressor.

In all the embodiments, anti-pumping protection means are integrated in the proportioning valves which each comprise a minimum passage section 34a, 34b, 34c, 34d configured to permit the passage of a minimum flow rate of compressed air when said proportioning valve is in the closed position. The minimum flow rates taken as a whole for each proportioning valve having a minimum passage section make it possible to ensure a minimum flow rate downstream of the compressor 12 in order to avoid pumping. According to the embodiments. one or some or all of the proportioning valves can comprise a minimum passage section, depending on the desired minimum flow rate of air. In the first and fourth embodiments, with reference to FIG. 1 and FIG. 4, the anti-pumping protection means also comprise a duct 30 for bypassing all of the cathodes, comprising a bypass valve 32 configured to permit the flow of no compressed air, some of the compressed air or all the compressed air in the bypass duct 30. The opening or the closing of the bypass valve 32 is controlled by the control device 24 so as to ensure the flow of a minimum flow rate in order to avoid pumping of the compressor.

In the second embodiment, with reference to FIG. 2, the anti-pumping protection means are only integrated in the proportioning valves 22a, 22b, 22c, 22d which each comprise a minimum passage section 34a, 34b, 34c, 34d configured to permit the passage of a minimum flow rate of compressed air when said proportioning valve 22a, 22b, 22c, 22d is in the closed position.

In the third embodiment, with reference to FIG. 3, the anti-pumping protection means are only integrated in the proportioning valves 20a, 20b, 20c, 20d which each comprise a minimum passage section 34a, 34b, 34c, 34d configured to permit the passage of a minimum flow rate of compressed air when said proportioning valve 20a, 20b, 20c, 20d is in the closed position.

The invention is not limited to the embodiments described. In particular, the turbine 18 and the turbine 28 can be one and the same turbine or two different turbines in the different embodiments illustrated.

1. A device for supplying compressed air to a plurality of cathodes of a fuel cell system, comprising:
a motorized compressor configured to provide a source of compressed air to all the cathodes;
a group of ducts configured to conduct the compressed air towards each cathode;
for each cathode, a proportioning valve upstream or downstream of said cathode configured to regulate the flow rate of compressed air passing through said;
anti-pumping protection means configured to permit the flow of a minimum flow rate of compressed air leaving the compressor,
a control device configured to control the speed of the compressor and the opening or closing of each proportioning valve and/or the operation of the anti-pumping protection means,
and in that at least one proportioning valve comprises a minimum passage section configured to permit the passage of a minimum flow rate of compressed air when said proportioning valve is in the closed position, each minimum passage section forming an anti-pumping protection means.

2. The supply device as claimed in claim 1, wherein the anti-pumping protection means comprises a duct for bypassing all the cathodes, and a bypass valve configured to allow the flow of no compressed air, some of the compressed air or all the compressed air in the bypass duct, and in that the control device is configured to control the opening or closing of the bypass valve.

3. The supply device as claimed in claim 1, further comprising means for measuring the pressure of the compressed air leaving the compressor, and in that the control device is configured to control the speed of the compressor and the opening or closing of each proportioning valve and the anti-pumping protection means depending on the data coining from the means for measuring the pressure of the compressed air leaving the compressor.

4. The supply device as claimed in claim 1, further comprising means for measuring the temperature of the compressed air leaving the compressor, and in that the control device is configured to control the speed of the compressor and the opening or closing of each proportioning valve and the anti-pumping protection means depending on the data coining from the means for measuring the temperature of the compressed air leaving the compressor.

5. The supply device as claimed in claim 1, further comprising means for measuring the flow rate of the compressed air leaving the compressor, and in that the control device is configured to control the speed of the compressor and the opening or closing of each proportioning valve and the anti-pumping protection means depending on the data coining from the means for measuring the flow rate of the compressed air leaving the compressor.

6. The supply device as claimed in claim 1, characterized in that the control device is configured to control the speed of the compressor and the opening or closing of each proportioning valve and of the anti-pumping protection means depending on the power to be provided by the fuel cell system.

7. The supply device as claimed in claim 1, characterized in that the control device is supplied with power by at least one fuel cell of the fuel cell system.

8. The supply device as claimed in claim 1, further comprising at least one heat exchanger arranged downstream of the compressor and upstream of the cathodes, which is configured to cool the compressed air.

9. The supply device as claimed in claim 1, further comprising an output turbine arranged downstream of the cathodes and configured to regulate the pressure of the compressed air downstream of the cathodes.

10. A fuel cell system comprising a plurality of fuel cells, each fuel cell comprising a cathode configured to receive compressed air, characterized in that the fuel cell system comprises a supply device configured to supply compressed air to at least two cathodes of said fuel cell system the supply device comprising:
a motorized compressor configured to provide a source of compressed air to all the cathodes;
a group of ducts configured to conduct the compressed air towards each cathode;
for each cathode, a proportioning valve upstream or downstream of said cathode configured to regulate the flow rate of compressed air passing through said;
anti-pumping protection means configured to permit the flow of a minimum flow rate of compressed air leaving the compressor,
a control device configured to control the speed of the compressor and the opening or closing of each proportioning valve and/or the operation of the anti-pumping protection means,
and in that at least one proportioning valve comprises a minimum passage section configured to permit the passage of a minimum flow rate of compressed air when said proportioning valve is in the closed position, each minimum passage section forming an anti-pumping protection means.
